(19) United States
(12) Patent Application Publication
(10) Pub. No.: US 2013/0201323 A1
(43) Pub. Date: Aug. 8, 2013

(54) Systems and Processes for Creating Dual-Media Images

(71) Applicants: Melissa Trott Davis, Austin, TX (US); Gregory Alan Davis, Austin, TX (US)

(72) Inventors: Melissa Trott Davis, Austin, TX (US); Gregory Alan Davis, Austin, TX (US)

(73) Assignee: Dabble Inc., Austin, TX (US)

(21) Appl. No.: 13/367,550

(22) Filed: Feb. 7, 2012

(51) Int. Cl. H04N 5/262; H04N 7/18

(52) U.S. Cl. 348/81; 348/239; 348/E05.051; 348/E07.085

(57) ABSTRACT

Systems and processes for creating dual-media images. More specifically, implementations provide processes for capturing an image of a subject as viewed from within one media and another image of the subject as viewed from within another media. The images can be synchronized and combined to create a dual-media image of the subject. Embodiments provide systems, apparatus, etc. for creating dual-media images from images of a subject as captured from within different media.

### BACKGROUND

Objects partially situated in one media and also partially situated in another media present certain difficulties for those who might desire to observe the entire object. More specifically, since the two media have different indices of refraction, they tend to create a reflective boundary (the surface of one or the other) between themselves. Reflections off of the boundary may render the boundary more or less opaque (or at least translucent). Thus, observers of such objects may not be able to see the entire object and how it interacts with the media.

For instance, swim coaches sometimes wish to view or videotape a swimmer as the athlete swims through the water and/or along the surface thereof. The surface of the water prevents air-based cameras from obtaining images of the submersed portions of the swimmer's body. Likewise, the surface also prevents underwater cameras from obtaining images of the exposed or over water portions of the swimmer's body. As a result, it has been heretofore impracticable to observe both the over and under water portions of the swimmer's body and, more specifically, both the over and under water portions as observed at some particular point in time.

In addition, movement of the object and/or environmental conditions might aggravate the inability to obtain images of the entire object. For instance, as the object moves, it might entrain potions of one media in the other media (even if only temporarily). In other words the object might “splash.” Of course, environmental conditions might also cause splashes. In the case of a swimmer the splashing propels droplets of water into the air. As is readily apparent, the splash (meaning the droplets of water) appear white and at least translucent or opaque to air-based observers. Likewise, the bubbles of air entrained in the water below the surface similarly create an opaque water/air mixture which obscures the swimmer. That is, bubbles can partially surrounded and obscure/eclipse the object. In addition, differences between the indices of refraction of the different media distort images captured from within one media by cameras focused for the other media. Most are familiar with this phenomenon which causes a rod passing through the surface to appear bent at the point where it penetrates the surface. Waves and other disturbances in the water make parts of the object appear to waver.

Some photographers have obtained so called split image photographs in which one single camera is placed with its lens at the boundary. It is then used to take a photograph with the boundary bisecting the captured image into an over water portion and an underwater portion. These split image photographs are sometimes referred to as “over-under” water photographs. But setting the focus of the camera to compromise between the different optical settings suggested by the different media often leads to one or both portions of the resulting image being out-of-focus. Furthermore, such compromise solutions fail to account for the apparent size change of the object caused by the differing indices of refraction. Indeed, most split image photographers take care to keep the subject in one or the other media to avoid the resulting discontinuities at the boundary. The boundary might also roll (or otherwise move) over the lens of the camera thereby potentially complicating the process of obtaining such split image photographs.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, processes, etc. for creating dual-media images from images taken from within one media and images taken from within another media. These dual-media images can be incorporated in animated “flip books,” stored in the form of digital moving images, stored as single shots, transmitted in such forms, etc.

Some embodiments implement processes for creating dual-media images of various subjects. Processes of the current implementation include accepting an over water image of a subject as taken by a first camera at an over water viewpoint. These processes also include accepting an underwater image of the subject which is synchronized with the over water image and taken by a second camera at an underwater viewpoint. In such situations, the underwater viewpoint was in alignment with and near the over water viewpoint when the images were taken. Furthermore, these processes include scaling one of the images to a scale associated with the other image and/or scaling both images to a common scale. A boundary artifact is also removed from the underwater image in such processes. In such implementations, the images are combined (with the boundary artifact removed from the underwater image) to form a dual-media image of the subject.

Various implementations provide processes for creating dual-media images. Such processes include accepting a first image of a subject at least partially situated in a first media (for instance air) and in a second media (for instance water). These media define a boundary there between. Moreover, in the current implementation, the first image is captured from a viewpoint in the first media while the second image is captured from a viewpoint in the second media wherein the viewpoints are aligned with each other and the images are synchronized. Processes of the current implementation also include removing an artifact associated with the boundary from at least one of the images. One of those images is scaled to a scale associated with the other image. In addition, the images are combined to form a dual-media image.

Various processes can also include aiming a first camera (positioned at the first viewpoint) at the subject and aiming a second camera (positioned at the second viewpoint) at the subject. In addition, processes can include adjusting the relative positions of the images to cause a portion of the subject in the dual-media image to have an aspect ratio that is approximately the same as an aspect ratio of the corresponding portion of the subject. Some processes include following the subject while obtaining the first and second images. With regard to the boundary artifact, some processes include detecting a contrast in one of the images between a portion of the boundary and a portion of one of the media (which is adjacent to that portion of the boundary). Some processes also include detecting a contrast between the portion of the boundary and a portion of the other media.

Furthermore, embodiments provide systems which include a camera mount and two cameras mounted to the camera mount. The cameras can be aimed at a subject a distance away from the camera mount and can be set to certain focal lengths so that when one camera is in one media and the other camera is in another media, the system captures corresponding in-focus images of the subject. In some embodiments, the two media (i.e., water and air) have differing indices of refraction.

In the alternative, or in addition, the mount can include an adjustment mechanism for adjusting the distance between the cameras (or rather their lenses). The mount can also include pivots for adjusting the aim of the cameras. If desired, the system can include a buoyancy control subsystem. The system of some embodiments can include a motor coupled to the camera mount that propels the system through one of the media. Furthermore, the system can include a timer in communication with the cameras for synchronizing the operation of the cameras. A processor and memory can be included in the system for, respectively, processing and storing the images.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates an apparent photograph or illustration which includes a dual-media image.

FIG. 2 illustrates an over water image.

FIG. 3 illustrates an underwater image.

FIG. 4 illustrates a cropped underwater image.

FIG. 5 illustrates a system for capturing over water and underwater images.

FIG. 6 illustrates a process for creating dual-media images.

FIG. 7 illustrates a process for calibrating a system for capturing dual-media images.

FIG. 8 illustrates a process for capturing over water and underwater images.

FIG. 9 illustrates a process for creating dual-media images.

FIG. 10 illustrates a block diagram of a system for creating dual-media images.

### DETAILED DESCRIPTION

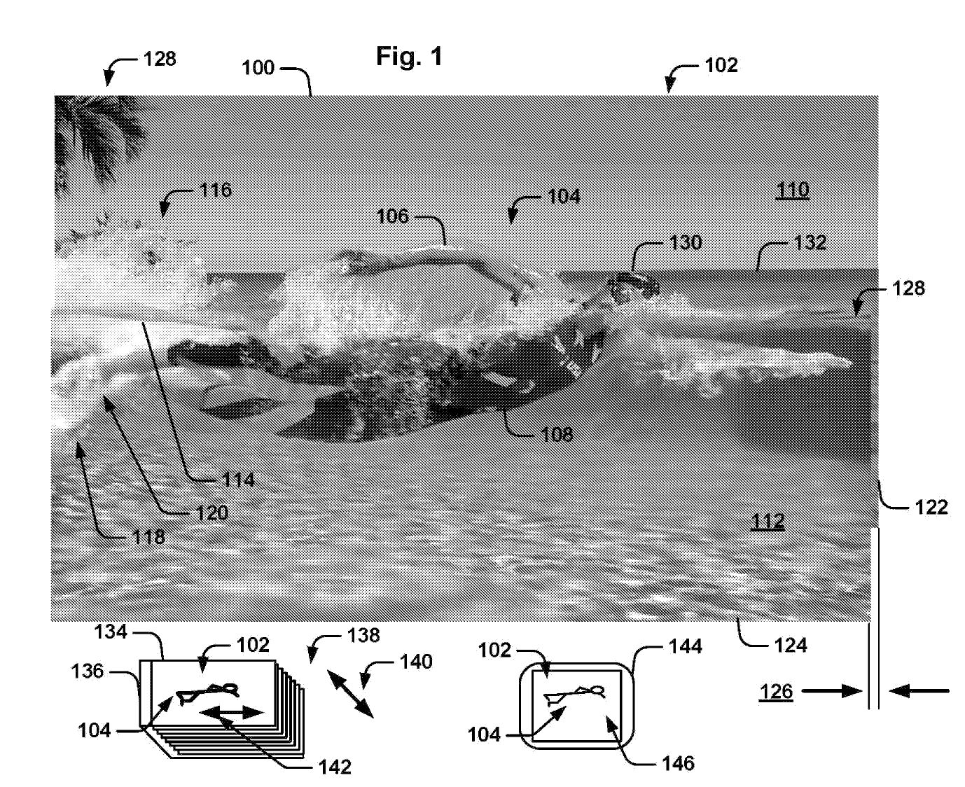

FIG. 1 illustrates an apparent photograph (or illustration) which includes a dual-media image. More specifically, FIG. 1 illustrates that the apparent photograph 100 includes a dual-media image 102 of a subject 104. The subject 104 possesses a portion of itself that is over the water (an over water portion 106) and a portion which is under the water (an underwater portion 108). The apparent photograph 100 also depicts the air 110 (partially characterized by the sky) and the water 112 (partially characterized by refractive effects such as the pattern of light cast on the bottom of the body of water 112). A boundary 114 or surface separates the air 110 and water 112 and often crosses a portion of the subject 104. In the situation shown in FIG. 1, the subject 104 is causing splashes 116 and thereby entraining bubbles 118 of air 110 in the water 112. The bubbles 118, waves, impurities, etc. in the water 112 cause distorted areas 120 in conventional images of the subject 104 and notably of certain areas of the subject under the water 112. More specifically, one or both of the media (water and air in the current situation) might have an index of refraction (and/or other optical properties) that, in conjunction with waves and other disturbances therein, cause the distorted areas 120 to appear.

In accordance with embodiments, the apparent photograph 100 includes an over water image 122 and an underwater image 124. As is disclosed further herein, these images are combined to form the apparent photograph 100 or dual-media image 102. While not necessary for the practice of embodiments, the apparent photograph 100 also includes an offset 126 between the over water image 122 and the underwater image 124. The apparent photograph 100, furthermore, depicts various objects 128 in addition to the subject 104 such as (in the illustrated scene) a palm tree and an underwater rock or block of concrete. With reference again to the subject 104, this particular subject has certain identifiable portions such as a head 130, a torso, legs, arms, etc. FIG. 1 also depicts a horizon 132.

Briefly, various systems, process, etc. cooperate to capture the over water image 122 and the underwater image 124. They also synchronize these images 122 and 124; scale and crop one or both of them; and combined them to form the dual-media image 102. FIG. 1, furthermore, illustrates a flip book 134 which can be used to display a sequence of dual-media images 102. The flip book 134 has a binding 136 which binds the sequence of dual-media images 102. A free end 138 of the flip book 134 (or pages thereof containing a sequence of dual-media images 102) allows a user to riffle through the dual-media images 102 in one or both directions as indicated by arrow 140. Arrow 142 indicates that as a user does so the subject 104 appears to move in the sequence of dual-media images 102. FIG. 1 also illustrates that the dual-media images 102 can be output on a monitor 144 as a moving image 146 or video such as those playable on cellular telephones, smart phones, computer displays, televisions, etc. With further reference to FIG. 1 it might now be interesting to disclose various features of FIG. 1 in more detail.

Apparent photographs 100 often depict the subject 104 moving at, or near, the boundary 114 although other possibilities are within the scope of the disclosure. For instance, the subject 104 could be situated in one of the media or transitioning from one to the other. Moreover, while the subject 104 happens to be a swimmer (i.e., a human being), the subject 104 could be many types of animate and inanimate objects. For instance, the subject 104 could be an animal, a machine such as a ship, a machine component, etc. The type of subject 104, therefore, does not limit the disclosure. Further still, the two (or more) media involved need not be water 112 and air 110. Rather, any media that form a boundary 114 there between could be involved. For instance, images involving media combinations such as water/oil, air/oil, water/water-vapor, etc. might be illustrated by apparent photographs 100. Moreover, the scene captured by such apparent photographs 100 need not be natural in character. For instance, the scene could be manmade such as those involved in engineering, scientific, or other types of tests, trials, operations, etc.

Still with reference to FIG. 1, the orientation of the apparent photograph 100 need not be aligned with the vertical or horizontal. For instance, the water 112 could be running downhill past a stationary subject 104. The apparent photograph 100 might be oriented in accordance with the slope of the hill in such situations. As a result, terms such as “over” or “under” are used herein more in the sense that the two media involved tend to separate from one another and therefore one image 122 or 124 is of the subject 104 as viewed in one media and the other image 124 or 122 is of the subject 104 as viewed in the other media.

Features related to the boundary 114 and conditions there about might also be interesting to disclose in some more detail. For instance, gravity (when present) will often cause the densest of the two media to settle under the other media. Moreover, surface tension of one media will usually cause that media to form a surface or boundary 114 with the other media. The potentially differing indices of refraction between the two media can cause that boundary 114 (as viewed from within one of the media and looking toward the other) to be opaque or translucent. In addition, or in the alternative, the differing indices of refraction might cause the boundary 114 to reflect light and/or distort images that happen to pass through the boundary 114. As a result of such factors, it might be impracticable to view the portions of the subject 104 that are in one media from vantage points within the other media. For instance, take the scene depicted in FIG. 1. With conventional apparatus, systems, processes, etc., a photograph of the scene taken from the air 110 would only depict the over water portion 106 of the subject 104. The underwater portion 108 of the subject 104 would be hidden, or at least obscured, by the boundary 114. Likewise, an image captured from within the water 112 would depict only the underwater portion 108 of the subject 104.

Still with reference to FIG. 1, splashes 116 and bubbles 118 further complicate the ability of conventional systems to capture meaningful images of the subject 104. Indeed, the subject 104 might cause the presence of the splashes 116 and bubbles 118 by, for instance, moving in the water 112. To further illustrate such situations, consider a swimmer. Swimmers often swim at or near the surface of the water 112 kicking with their legs and stroking with their arms. Many of these actions will bring a limb out of the water rather quickly thereby creating a splash 116. That limb will then be brought back into contact with the water 112 creating another splash 116 and entraining bubbles 118 into the water 112 as the limb proceeds into and through the water. These actions also cause waves in the water 112.

The differing indices of refraction of the air in the bubbles 118 and the surrounding water 112 render those droplets a white area on the underwater images 124. The differing indices of refraction between the droplets of water in the splashes 116 and the surrounding air 110 also render these splashes 116 a white area on conventional over water images 122. As a result, the splashes 116 and bubbles 118 obscure conventionally captured images while apparently adding little, if any information, to such conventional images. It might also be interesting to note that surface tension tends to hold the boundary 114 (or, rather, boundary layer) as a more or less continuous structure across the scene.

A word or two might also be in order regarding the over and under water images 122 and 124 depicted by apparent photograph 100. More specifically, since the cameras which obtained theses images were/are located in their respective media, each camera captures an image 122 or 124 through media 110 and 112 with potentially differing indices of refraction. Thus, the scale of the captured images 122 will therefore likely differ and give rise to the offset 126 when the images 122 and 124 are scaled and then combined.

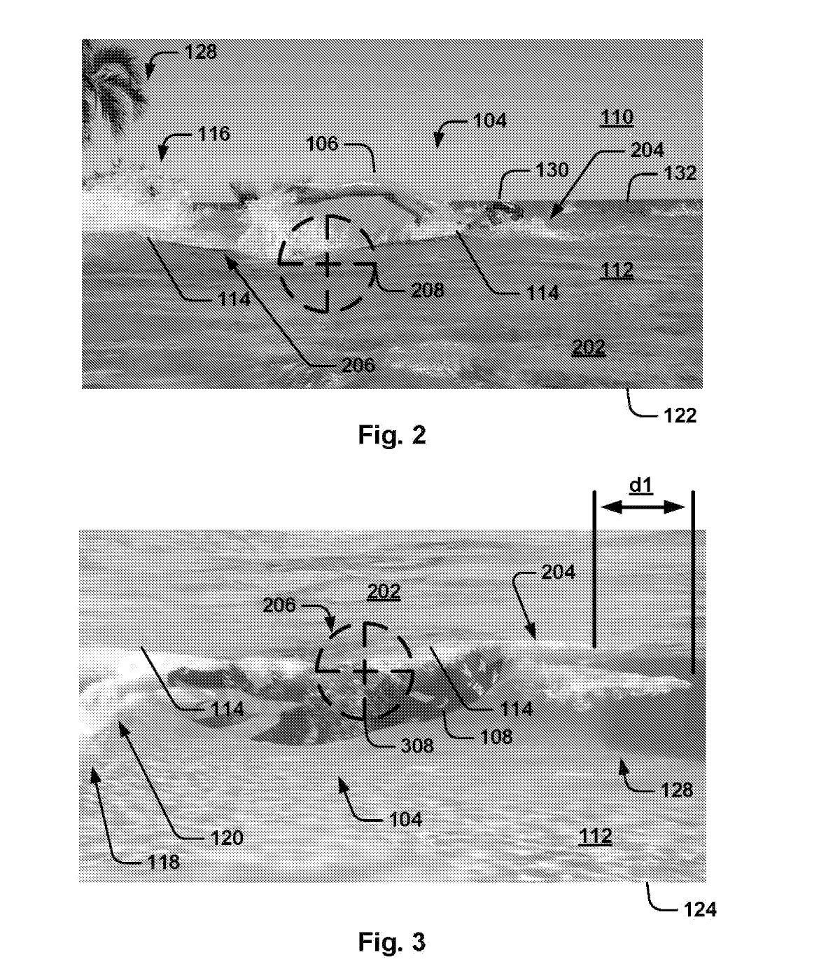

Horizon 132 also appears in many dual-media images 102. The horizon 132 can be used as a reference to identify horizontal aspects captured in dual-media images 102 such as the overall boundary 114. Of course, the horizon 132 is not the only aspect of such images that can identify, register, etc. horizontal features. For instance, some objects 128 can aid with such activities. On a different note, some objects 128 might move between the capture of differing sequential images 122 and 124 thereby providing mechanisms useful in synchronizing over and under water images 122 and 124. Indeed, artificially constructed objects (metronomes, flashing lights, etc.) can be placed in scenes of interest for such reasons. Having discussed features illustrated by FIG. 1, features illustrated in FIG. 2 will now be further disclosed.

FIG. 2 illustrates an over water image. In addition to many features of FIG. 1, FIG. 2 illustrates the water surface 202, a bow wave 204, a corresponding trough 206, and a cross hair 208. Any subject 104 moving relative to and through a media (that is at least somewhat of a fluid) will create a bow wave 204 as it moves through the media (or the media moves passed it). The bow wave 204 tends to occur in front of the subject 104 (in the direction of travel) and might be quite noticeable or somewhat insignificant depending on a variety of circumstances. Nonetheless, a moving subject 104 will create a bow wave 204 in one or both media. As with any wave phenomenon, a moving subject 104 will also create the corresponding trough 206 that trails the bow wave 204. Of course, the bow wave 204 and trough 206 are related phenomenon. Yet, for illustrative purposes they happen to be labeled separately.

FIG. 2 also illustrates the cross hair 208. The crosshair 208 can be associated with an over water camera and can be used to aim that camera at a target on the subject 104. That target might be a particular feature of the subject 104 or it can be something placed on the subject 104. Moreover, the target can be placed on the subject 104 before the subject 104 begins moving or is even immersed in one of the media. As disclosed elsewhere herein, the boundary 114 (or surface 202) hinders the capture of images from the air containing meaningful features of the underwater portions 108 of the subject 104. Indeed, the opacity, translucency, reflections, etc. associated with the boundary 114 give rise to the appearance of the surface 202.

FIG. 3 illustrates an underwater image. As with, FIG. 2, this drawing illustrates a cross hair 308. This particular cross hair 308 can be associated with an underwater camera used to capture the underwater image 124. It too can be used to aim that camera at the subject 104 or, if desired, a target thereon. Together, therefore, the cross hairs 208 and 308 can be used to register the over and underwater cameras (discussed further with reference to FIG. 5) with each other. Indeed, cameras can be held in a known (or selected) spatial relationship with each other thereby allowing the over and underwater images 122 and 124 to be registered with each other. FIG. 3 also illustrates that the underwater image 124 has associated therewith a particular scale as illustrated by some feature of the image (for instance, here, object 128) and as shown by distance d1. FIG. 3 also illustrates that certain features visible in FIG. 2 (above the water) are also visible under the water 112. For instance, the surface 202 (or underside thereof), the bow wave 204, and trough are visible in the underwater image 124 of FIG. 3 as well as in FIG. 2.

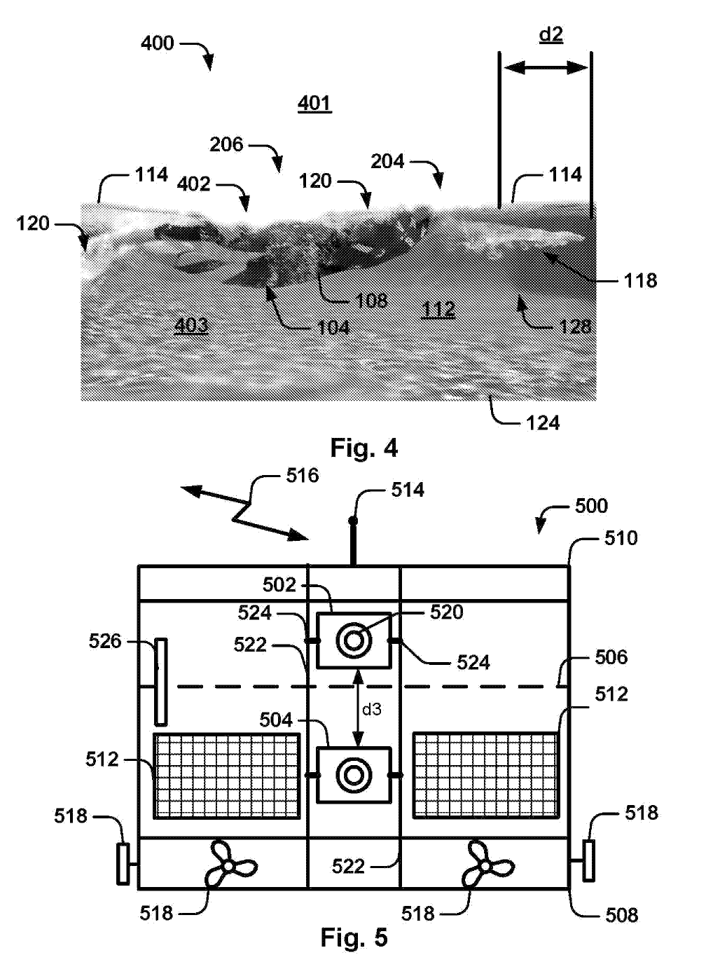

FIG. 4 illustrates a cropped underwater image. More specifically, the cropped image 400 includes a cropped area 401, one or more eclipsed areas 402, and one or more distorted areas 120. The cropped image 400 can be created from the over or under water images 122 and 124. Here, though, the cropped image 400 has been created from the underwater image 124. More specifically, in the current embodiment, the underwater image 124 was cropped of all areas to one side of the boundary 114.

Additionally, in the vicinity of the subject 104, the boundary 114 (or the artifact associated therewith) was cropped from the underwater image 124. The bubbles 118 and disturbed areas 120 were left in the cropped image 400 (thereby preserving the appearance of the eclipsed areas 402). Although, they could have been cropped from the underwater image 124 too if desired. Nonetheless, as a result, the cropped image 400 depicts the scene as it appears from under the water 112 except that the boundary 114 (and underside of the surface 202) has been removed. In the current embodiment, white space replaces these artifacts, features, etc. of the underwater image 124. Note that the other image, here over water image 122, could have been cropped instead (or in addition). But, since the boundary 114 appears in the underwater image 124, cropping the over water image 122 would possibly result in a dual-media image 102 having the boundary 114 artifact visible in the vicinity of the subject 104. Nonetheless, a user can choose to crop the image in which the boundary 114 related artifact appears for various media combinations.

FIG. 4 further illustrates that the underwater image 124 (or cropped image 400) was scaled as shown by the apparent difference between distance d2 and that same distance d1 (see FIG. 3) in the un-scaled underwater image 124. The scaling of the cropped image 400 can be done in such a manner that the cropped image 400 more or less matches the scale of the over water image 122. In accordance with other embodiments, though, the over water image 122 can be scaled to match that of the underwater image 124 or the cropped image 400. Of course, both images could be scaled to match some other selected scale and still be within the scope of the disclosure. For instance, a feature of the subject 104 (or other object 128) visible in both the over and underwater images 122 and 124 (and/or the cropped image 400) could be used to provide the scale to which both images are scaled.

FIG. 5 illustrates a system for capturing dual-media images. More specifically, the system includes a mount 500 for an over water camera 502 and an underwater camera 504. FIG. 5 illustrates a design water line 506 where it might be expected that the boundary 114 comes to rest when the mount 500 is placed in the water 112 and floats therein. Moreover, FIG. 5 also illustrates that the mount 500 can include weights 508, floatation aids 510, and other aspects of a buoyancy control subsystem. Furthermore, the mount 500 can include one or more LEDs 512 and an antenna 514 that transmits/receives a signal 516. The mount 500 can also include one or more motors 518 for propelling the mount 500 through the media. Additionally, FIG. 5 illustrates that the cameras 502 and 504 can each include a lens 520. Moreover, the cameras 502 and 504 can ride on or be positioned on rails 522 and/or pivots 524. In some embodiments, the mount 500 includes a water level sensor 526, gyroscope, and/or other position/orientation sensing/maintaining devices.

With continuing reference to FIG. 5, the mount 500 can perform a variety of functions. For instance, the mount 500 can include mount points (for instance, the rails 522) for the cameras 502 and 504. Moreover, the mount 500 can hold the cameras 502 and 504 in a selected relationship with each other. Of course, the rails 522 of the mount 500 can allow a user to adjust that relationship and, with the aid of certain mechanical features (i.e., latches), to fix that relationship for some time. FIG. 5 also illustrates the relationship between the cameras 502 and 504 by the distance d3 there between. That distance d3 sometimes depends on the scale of the scene to be captured. But, for capturing images 122 and 124 of swimmers from about 10 feet away there from, it has been found that a distance d3 of 5-6 inches produces satisfactory results. Small distances d3 also allow the points of view of both cameras 502 and 504 to be sufficiently similar so that the difference there between does not significantly skew or distort one image 122 or 124 relative to the other image 124 or 122.

The weights 508, floatation aids 510, etc. of the mount 500 can be configured so that the boundary 114 will likely coincide with the water line 506 (absent some disturbance). That water line 506 can be maintained at a location between the cameras 502 and 504 by the buoyancy control subsystem. Moreover, the pivots 524 allow users to orient the cameras 502 and 504 and thereby aim the cameras 502 and 504 at the subject 104.

The cameras 502 and 504 themselves can be adapted for use in either or both media into which the mount 500 might be placed. For instance, the cameras 502 and 504 can both be water-resistant or “waterproof” cameras. Moreover, the cameras 502 and 504 can be remotely actuated if so desired. One or more of the lenses 520 can be wide-angle, fish eye, etc. lenses. These lenses can be focused by automatic and/or manual mechanisms in, or associated with, the cameras 502 and 504. Moreover, the LEDs 512 can be positioned to illuminate the scene viewed by one or both cameras 502 and 504 and, more specifically, the underwater scenes viewed by the underwater camera 504. These LEDs can be “super bright” LEDs although other illuminations sources (such as xenon flash devices, strobes, etc.) are within the scope of the disclosure.

A wireless communication system (a portion of which is housed by the mount 500) of some embodiments can include the antenna 514. In this way, mounts 500 of the current embodiment can communicate with (and be controlled by) users in relatively remote locations such as on the deck of a pool, in a boat, etc. Of course, such remote control subsystems can operate via various wireless signals 516 and according to various protocols such as “Wi-Fi,” other electromagnetic-related signaling technologies, infrared technologies, ultrasound technologies, etc.

As disclosed elsewhere herein, some subjects 104 (and/or media) are capable of movement. As such, the mount 500 can include the motors 518 (and various supporting features or propulsion subsystems) which are configured to propel the mount 500 through the media. In the alternative, or in addition, the mount 500 can be configured to be grasped and moved about manually by a user. Furthermore, the water level sensor 526 or other orientation-sensing devices can sense the position/orientation relative to the water 112 and or the boundary 114 so that the mount 500 can react accordingly to maintain the over water camera 502 over the water 112 and the underwater camera 504 in (or under) the water 112. Of course, the mount 500 could allow one or both cameras to straddle the boundary 114.

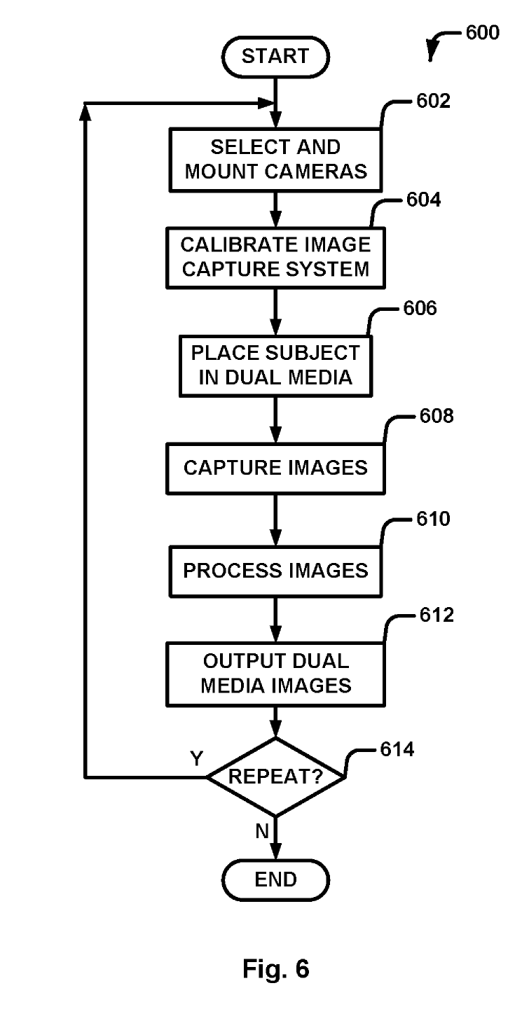

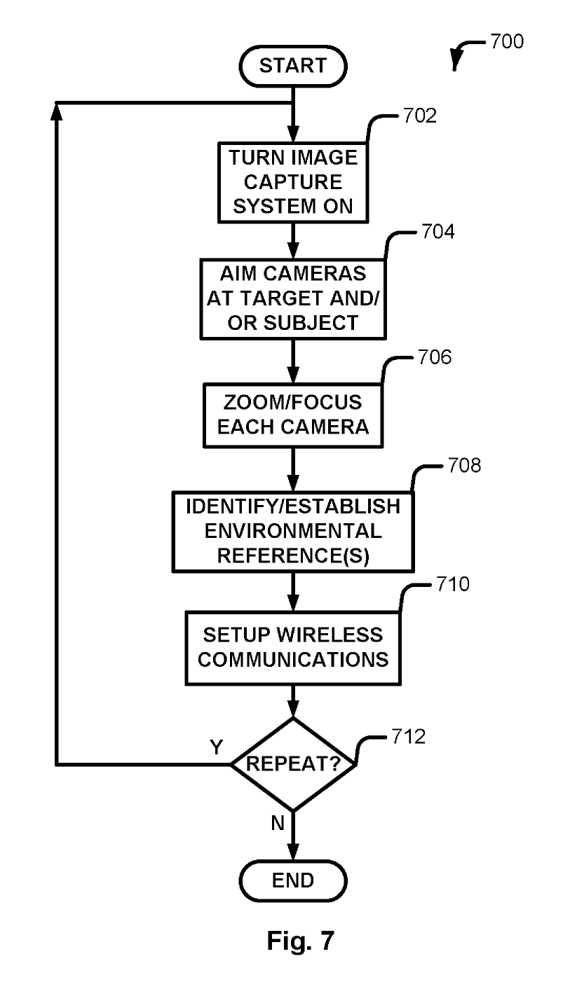

FIG. 6 illustrates a process for creating dual-media images. The process 600 of the current implementation can incorporate some or all aspects of processes 700, 800, and 900 (see FIGS. 7, 8 and 9 respectively). With continuing reference to FIG. 6, the process 600 can begin with the selection of the cameras 502 and 504. The selection of the cameras 502 and 504 can account for the differing media in which they might come into to contact. For instance, waterproof cameras can be selected for use in aquatic environments. Moreover, the selection of the cameras 502 and 504 can include selecting the lenses 520 thereof to, for instance, account for the differing indices of refraction of the various media. In some cases, a fish-eyed lens or other wide angle lens is selected for over water camera 502 and/or underwater camera 504. The selected cameras can also be attached/mounted to the mount 500 as indicated by reference 602. If desired, the distance d3 can be adjusted and set to establish a fixed relationship between the cameras 502 and 504. See reference 602.

Reference 604 indicates that an image capture system (including the cameras 502 and 504) can be calibrated during process 600. FIG. 7 and the associated description disclose further aspects of calibrating such systems. Returning to FIG. 6, reference 606 illustrates that the subject 104 can be placed in one or both media as might be desired. For instance, a swimmer might enter the water 112, a ship might be launched or otherwise positioned in a body of water, or an engineering component might be mounted in a test fixture located in (or subject to) both media.

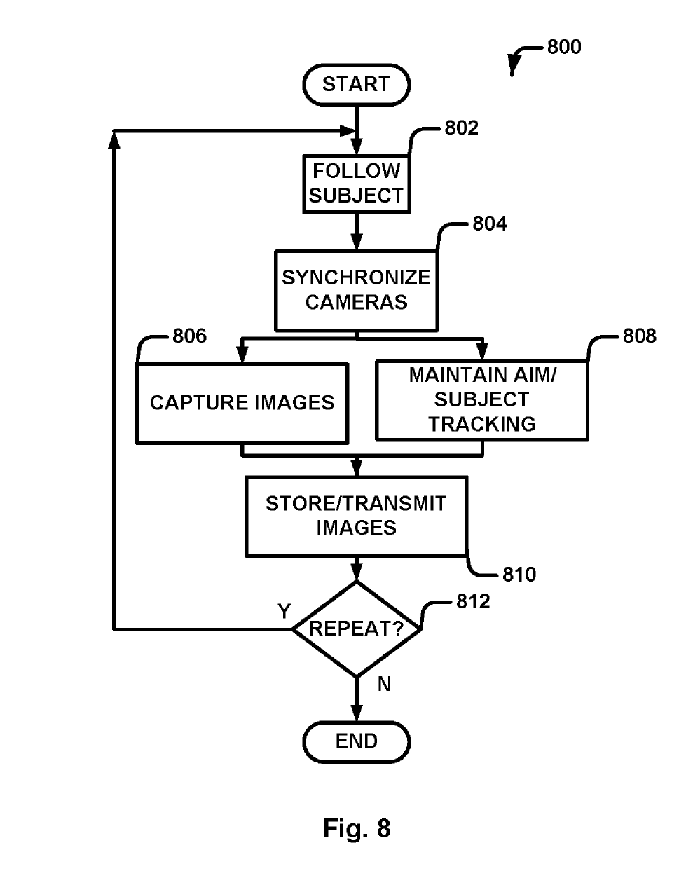

Reference 608 indicates that the over and underwater images 122 and 124 can be captured. The capture of those images 122 and 124 can occur as the subject 104 moves relative to one, or both, of the media and can therefore be a capture of sequential images in various formats. The JPG, JPEG, MPG, MP3, etc. formats can be used to capture, store, transmit, etc. the images. The capture of the images 122 and 124 is disclosed further herein with reference to FIG. 8.

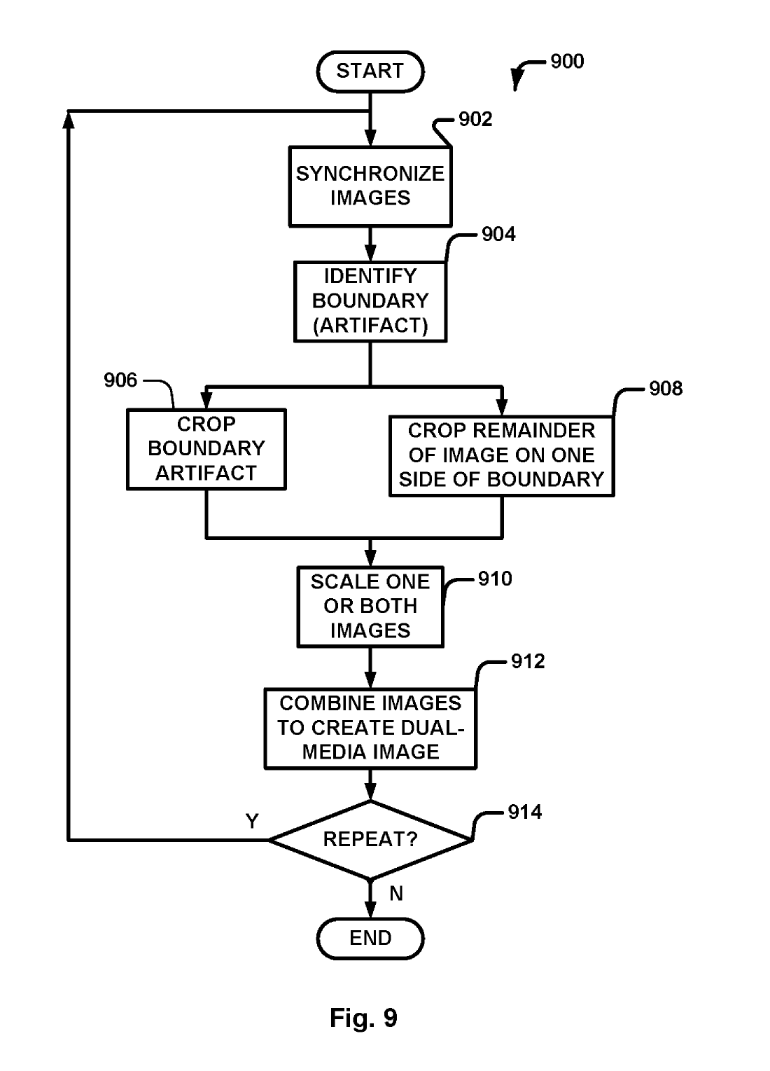

With continuing reference to FIG. 6, process 600 can continue at reference 610 which indicates that the captured images 122 and 124 can be processed as desired. For instance, one or both of the captured images 122 and 124 can be cropped, scaled, and combined. FIG. 9 and the associated disclosure provided herein further explore processes of capturing the images 122 and 124 to, for instance, produce dual-media images 102.

At reference 612, dual-media images 102 are illustrated as being output in various fashions. For instance, the dual-media images 102 can be displayed, stored, transmitted, etc. Moreover, the output of the dual-media images 102 can occur in real time, on some scheduled basis, as desired, etc. Furthermore, all or portions of process 600 can be repeated as desired. See reference 614. Note also that process 600 can be performed electronically and/or with hard copy images 122 and 124 as might be desired.

FIG. 7 illustrates a process for calibrating a system for capturing dual-media images. The process 700 can begin with turning the mount 500 on. Process 700 can also include turning on the various subsystems, and/or supporting equipment (which can be located on deck, on the shore, other remote locations, etc.) of the mount 500 if any. See reference 702. The process 700 can also include aiming the cameras 502 and 504 at the subject 104 or a target on the subject 104. Note that, when possible, using one target to aim both cameras 502 and 504 (with the relationship between the cameras 502 and 504 fixed) can facilitate registering the images taken by the cameras 502 and 504 with each other. See reference 704.

Moreover, process 700 of the current implementation can include focusing the cameras 502 and 504. In this manner, the over water images 122 to be taken by the over water camera 502 and the underwater images 124 to be taken by the underwater camera 504 can both be in focus independently from each other. Note that in addition, or in the alternative, auto-focus features can be included in the cameras 502 and 504. If so users can confirm that both cameras 502 and 504 have focused themselves in a satisfactory manner. Also, auto-focus features can facilitate capturing in-focus images 122 and 124 even if the subject 104 moves during image capture. See reference 706.

Process 700 can also include identifying environmental references that might have some use in synchronizing, scaling, registering, etc. the images 122 and 124. For instance, the horizon 132 can be used to identify the horizontal orientation of various objects (and/or the subject 104) in the images 122 and 124. Of course, with a horizontal reference (or some other reference) identified, other such references (for instance, a vertical reference) can be derived there from and used in a similar fashion. Moreover, if a dimension of an environmental reference is known (or can be determined) then that dimension as it appears in the over water and underwater images 122 and 124 can be used in scaling various images 122 and/124. In the alternative, or in addition, some feature of the subject 104 can be used to aid the scaling process.

Moving and/or changing environmental references can also be identified at reference 708 or at other times. For instance, a moving or changing reference can be used (as is disclosed further with reference to FIG. 9) to aid in synchronizing the over water and under water images 122 and 124. If desired, wireless communications between the mount 500 and various support systems can be established as indicted at reference 710. Process 700 can repeat in whole or in part as indicated at reference 712. Or, if desired, the process 700 can terminate.

FIG. 8 illustrates a process for capturing over water and underwater images. Process 800 can begin with the mount 500 following the subject 104. For instance, a diver or swimmer can maneuver the mount 500 through the water 112. In the alternative, or in addition, the motors 518 can propel the mount 500 through the water 112. In some embodiments, the cameras 502 and 504 can ride on a zip line. See reference 802. In accordance with various implementations, moreover, the operation of the cameras 502 and 504 can be synchronized as the images 122 and 124 are captured. A timer can trigger the cameras 502 and 504 to capture images 122 and 124 respectively at the same time if desired. See reference 804.

In the alternative, or in addition, environmental references can be used to aid in synchronizing the images 122 and 124 after the fact. In other words, the cameras 502 and 504 can operate independently of each other capturing multiple sequential images over a given period of interest. At some time, the series of over water images 122 and the series of underwater images 124 can be compared to determine pairs of corresponding images 122 and 124 which were captured at about the same time. In the alternative, the images 122 and 124 can be compared to determine pairs of images 122 and 124 captured within such an amount of time from one another that the positions of the subject 104 in each of the images 122 and 124 are similar enough for the user's purposes. The synchronization of some images 122 and 124 is further disclosed with reference to FIG. 9. See reference 804.

With continuing reference to FIG. 8, the process 800 of the current implementation includes capturing the images 122 and 124 as well as maintaining the aim of the cameras 502 and 504 on the subject. See references 806 and 808. At reference 806, the cameras 502 and 504 capture (respectively) over water images 122 and underwater images 124 of the over water portions 106 and underwater portions 108 of the subject 104. In some scenarios, the cameras 502 and 504 capture these images 122 and 124 as the subject 104 is moving. But in other scenarios the subject 104 can be stationary or moving at some intermediate speed. Moreover, as noted elsewhere herein, the cameras 502 and 504 can be synchronized with a timer during the image capture or can be synchronized by comparison of corresponding images 122 and 124.

In some implementations, the mount 500 follows the subject 104. Doing so can allow the cameras 502 and 504 to stay focused on the subject 104 and within a certain distance there from. As sometimes happens, though, it might be the case that the subject 104 turns from the mount 500 and/or the mount 500 falls behind (or passes) the subject 104. As a result, the line of sight of the cameras 502 and 504 might skew from looking directly at the head-on front or lengthwise side of the subject 104. That is, they might skew from a perpendicular relationship with the subject 104. It has been noted that, as the subject 104 and the line of sight of the cameras 502 and 504 skew, the apparent thickness of the boundary 114 in the vicinity of the more distant end of the subject 104 increases. Meanwhile, the apparent thickness of the boundary 114 in the vicinity of the closer end of the subject 104 begins to decrease. While such situations are within the scope of the disclosure, it has been found that generally keeping the general orientation of the subject 104 and the line of sight of the cameras 502 and 504 approximately perpendicular to each other results in dual-media images 102 with more aesthetically pleasing qualities. Thus, process 800 can include keeping the subject 104 in a roughly perpendicular relationship with the line of sight of the cameras 502 and 504 as indicated by reference 808.

Of course, the mount 500 need not be positioned to take side view images of the subject 104. Indeed, the mount 500 could be stationary to capture images as the subject 104 moves past the cameras 502 and 504. In the alternative, or in addition, the mount 500 could be positioned in front of the subject 104 in which case it would follow the subject in the sense that it would move in accordance with the actions of the subject 102. Here, therefore, the mount 500 could be said to “follow” the subject 104 by “proceeding” it. Or, in some situations, the mount 500 could follow the subject 104 from behind it thereby obtaining images of the subject 104 from the rear.

The process 800 can also include storing, transmitting, and/or otherwise outputting the images 122 and 124. For instance, the images can be stored in some storage media (or medium) such as a computer readable media, memory, or even as hard-copy images among other alternatives. In addition, the images 122 and 124 can be transmitted to some remote device/location and stored or processed there. See reference 810. Of course, the process 800 can repeat in whole or in part as desired. See reference 812.

FIG. 9 illustrates a process for creating dual-media images. More specifically, FIG. 9 illustrates the process 900 for processing over water images 122 and underwater images 124 to create dual-media images 102. Process 900 can begin with synchronizing the images 122 and 124. See reference 902. Synchronizing the images 122 and 124 can be performed in real time by, for instance, timing the image capture operations of the over water camera 502 and of the underwater camera 504 with a timer or some other mechanism. For instance, if a user wishes to observe a swimmer's stroke, images 122 and 124 captured within about 0.01 or even 0.1 seconds of each other might be sufficiently close as to produce meaningful dual-media images 102 of the subject 104. In other situations, such as monitoring flutter associated with a high speed propeller of a boat as the propeller transitions from water-to-air and back might suggest different time frames within which to “synchronize” the images 122 and 124. Thus, in some situations higher precision (for instance 0.001 seconds or smaller) time frames might be called for. In other situation, less precise (for instance 1.0 seconds, 10 second, etc.) time frames might be appropriate. Nonetheless, users in their various fields of practice can choose an appropriate time frame and act accordingly since cameras with rapid capture rates (millions of frames per second) and much slower capture rates are available.

Furthermore, objects 128 in the images 122 and 124 can be used to synchronize the images. For instance, a metronome, flashing light, clock, etc. can be placed in the field of view of the cameras 502 and 504 to provide timing information with which the images 122 and 124 can be synchronized by comparing pairs of images 122 and 124 for situations wherein the moving objects are in the same position, orientation, etc. In addition, or in the alternative, the movement of the subject 104, portions of the subject 104 (appearing in both the over water images 122 and the underwater images 124), etc. can be used to find synchronized pairs of images 122 and 124. One technique for identifying synchronized pairs of images 122 and 124 is to identify a set of images 122 and 124 in which some observable portion of the subject 104 moves across the boundary 114. Since that event will likely be visible in both sets of images 122 and 124, a synchronized pair of images 122 and 124 might be found in that vicinity in the sequential images 122 and 124. Of course, the cameras 502 and 504 can project timing reference information into the images 122 and 124 which they capture to such ends if desired.

It is also noted that, once a pair of synchronized images 122 and 124 has been identified, that pair can be used to identify other synchronized pairs of images 122 and 124. For instance, with some sets of sequential images 122 and 124 it can be the case that a periodicity between synchronized images 122 and 124 might be observable. Accordingly, by advancing/receding through the sequences of images 122 and 124 by some number of images it can be expected that synchronized images 122 and 124 will be found. For instance, if every nth pair of images 122 and 124 happens to be synchronized, identifying one pair of synchronized images 122 and 124 leads to the identification of potentially numerous other synchronized images. It might be the case though that the cameras 502 and 504 capture images at rates that do not have a one-to-one relationship. In such cases, a “beat” might exist between the captured series of images 122 and 124 so that it might require more images 122 and 124 in one sequence of images than in the other for pairs of synchronized images to occur. Moreover, it might be the case that no such periodicity can be readily identified. In which case, comparing images 122 and 124 on a one-by-one basis might be a practicable way to identify synchronized pairs of images 122 and 124.

With continuing reference to FIG. 9, the boundary 114 or its corresponding artifact in a synchronized underwater image 124 can be identified. See reference 904. Of course, where a media combination other than air/water has been observed (or is being observed), the boundary 114 might occur in one or the other of the sequences of images 122 or 124 depending on the optical properties of the media involved. Nonetheless, the properties (optical and/or otherwise) of those media might allow for the captured images 122 and 124 to provide clues as to the location and/or identity of the boundary 114. For instance, at least in air 110 and water 112 scenes, the boundary 114 tends to be darker than either the air 110 or the water 112. Of course, that contrast might differ with other media combinations. For instance, it could be the case that the boundary 114 is darker than the two media, brighter than one of the media, etc. Since the bow wave 204 and trough 206 will often possess somewhat predictable locations and profiles (as seen from the side), these surface-related phenomenon can be used to identify the boundary 114 in either or both images 122 and/or 124.

The entrainment and/or splashing of one media into the other might also provide clues as to the location of the boundary 114 in various areas of the images 122 and/or 124. For instance, as seen in the underwater image 124, the air bubbles 118 will appear white and will tend to appear in groups near where some object has entered the water 112. The bubbles 118, though, will only appear in the water 112. In other words, any location in the underwater image 124 where a mass of bubbles 118 stops along a continuous or somewhat continuous line, arc, etc. might indicate the location of a portion of the boundary 114.

Various splashes 116 can also indicate the location of the boundary 114 (or portions thereof). As with the bubbles 118, the splashes tend to appear white and along or near the boundary 114. Thus, the presence and/or location of the splashes 116 provide clues as to the location of the boundary 114. It has been found that, by using these and/or other clues, much of the boundary 114 can be identified. See reference 904.

With continuing reference to FIG. 9, process 900 of various implementations includes cropping the boundary 114 from the underwater image 124. In some processes, the boundary 114 is only cropped from those regions of the underwater image 124 where it obscures the image of the subject 104. See reference 906. In addition, the surface 202 (as seen in the underwater image) can be cropped from the underwater image 124. Often, this entails starting at the boundary 114 (or where it was) and cropping everything on one side of the boundary 114. See reference 908.

Reference 910 indicates that one or both images 122 and/or 124 can be scaled. As noted elsewhere herein, the potentially different indices of refraction, optical settings of the cameras 502 and 504, locations of the cameras, orientations of the cameras, etc. can produce images 122 and 124 having different scales. As a result, some processes 900 include scaling one image 122 or 124 to match the scale of its corresponding image 124 or 122. Often, this can involve identifying an object 128 in images taken from both media and finding a pair of apparent distances (respectively d1 and d2) associated with the same feature of that object (for instance, a pier or post of a dock) in both images 122 and 124. For instance, a portion of the subject 104, target, etc. that moves between the over water images 122 and the underwater images 124 can be used to identify the scales of the images. Thus, the size of one or both images 122 and/or 124 can be increased/decreased until their scales are approximately equal.

At reference 912 the (scaled) images 122 and 124 can be combined. However, combining the images 122 and 124 along the area from which the boundary 114 was cropped can lead to certain aesthetically undesirable results. For instance, combining the pairs of synchronized images 122 and 124 can result in a visible gap(s) between the un-cropped areas 403 of the synchronized images 122 and 124 where the boundary 114 was removed. If the un-cropped areas 403 of the images 122 and 124 are brought into abutting relationship to close that gap(s), then the apparent aspect ratio of objects crossing the gap will become foreshortened generally in a direction crossing the gap.

Take for instance, the head 130 of the subject 104. If the head 130 crosses the boundary 114, cropping the boundary 114 might leave a visible gap across the image of the head 130. Some viewers of the combined image might find such a gap to be less than pleasing. However, bringing the images 122 and 124 into abutting relationship to eliminate the gap would cause the image of the head 130 to take on more of a foreshortened, oval, or oblong shape than the actual head 130 exhibits. Some processes, therefore, leave the un-cropped areas 403 of the synchronized images 122 and 124 spaced apart by the distance of the cropped boundary 114. Moreover, in some implementations, the resulting gap is filled with the images of splashes 116 and/or bubbles 118. In the alternative, or in addition, the gap (or portions thereof) can be filled with “white” or some other default texture, fill, etc. as might be desired. Of course, the boundary could be left in the cropped image if desired thereby avoiding the occurrence of such a gap. One way or another, the synchronized images can be combined as indicated by reference 912.

The process 900 can be repeated as desired. For instance, where sequences of images 122 and 124 have been captured (or are otherwise available) the process can repeat for some or all of the synchronized images 122 and 124 in those sequences. Otherwise, if desired, the process 900 can end at some point. See reference 914.

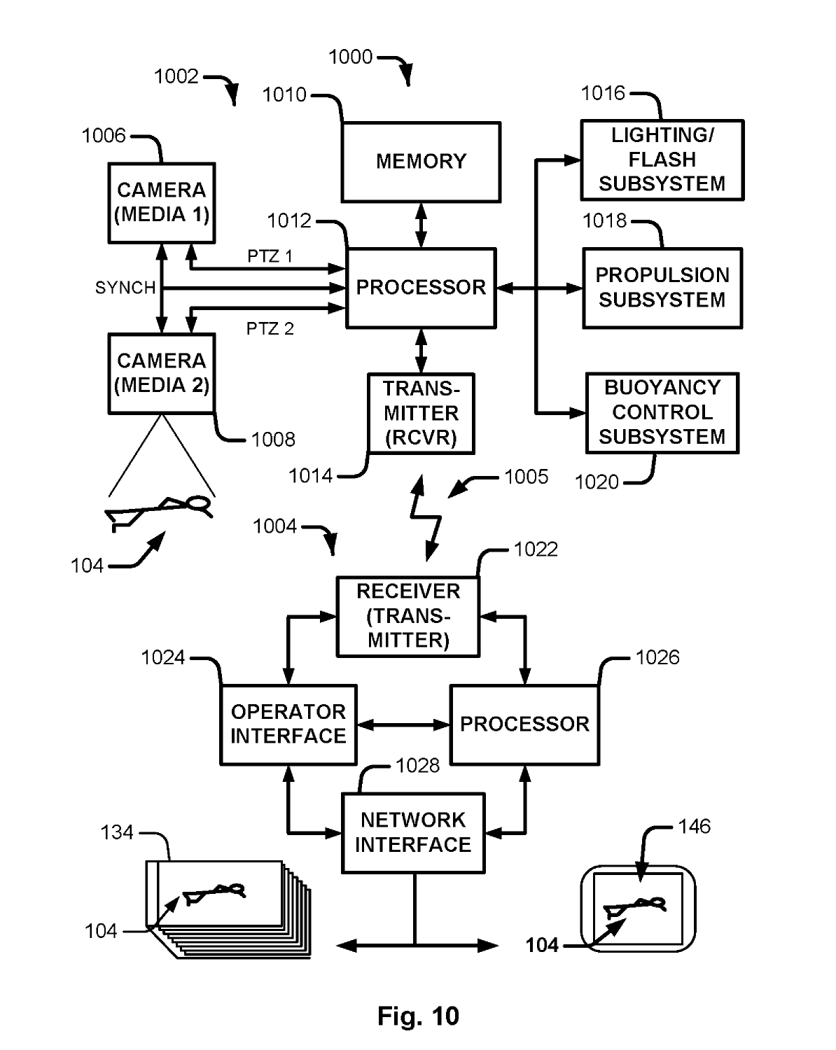

FIG. 10 illustrates a block diagram of a system for creating dual-media images. The system 1000 of the current embodiment includes a camera mount 1002 and a remote station 1004 linked by a wireless signal 1005. The camera mount 1002 includes two cameras 1006 and 1008. One camera 1006 (in operation) is often in a first media and the other camera 1008 is often in a second media. The camera mount 1002 also includes a memory 1010, a processor 1012, a transmitter 1014, a lighting subsystem 1016, a propulsion subsystem 1018, and a buoyancy control subsystem 1020. The remote station of the current embodiment includes a receiver 1022, an operator interface 1024, a processor 1026, and a network interface 1028.

The system illustrated by FIG. 10 can be used to obtain synchronized pairs of over water images 122 and underwater images 124 and to combine them to form dual-media images 102. The dual-media images 102 can be output in still photographs, flip books 134 and/or moving images 146. Moreover, the camera mount 1002 can be deployed into an environment in which the two media exist. For instance, the camera mount can be deployed into a pool, pond, lake, river, ocean, etc. to obtain over water images 122 and underwater images 124. In contrast, the remote station 1004 can remain in a benign environment. Thus, the remote station 1004 could be deployed on a pool deck, boat, island, etc. without departing from the scope of the disclosure.

Moreover, the camera mount 1002 can gather the over water images 122 and the underwater images 124 and transmit them to the remote station 1004 via the wireless signal 1005. The wireless signal 1005 can operate in accordance with a Wi-Fi protocol and/or can be any type of signal capable of conveying information from the camera mount 1002 to the remote station 1004 and vice versa. For instance, the wireless signal could operate by electromagnetic, infrared, ultrasonic, etc. principals. In addition, or in the alternative, communications between the camera mount 1002 and the remote station 1004 could occur via a wired interconnection.

The memory 1010 of the current embodiment is a computer readable memory which contains a variety of information. That information can include electronic files, folders, etc. containing apparent photographs 100, dual-media images 102, over water images 122, underwater images 124, cropped images 400, etc. The memory can also store processor executable instructions for operating the mount 500 and/or processing the various images in accordance with the current disclosure. Note that the remote station 1004 can include a memory also.

With continuing reference to FIG. 10, the processor 1012 can be any type of processor such as a microprocessor, a reduced instruction set computer (RISC) processor, an application specific integrated circuit (ASIC), etc. In the alternative, or in addition, the processor 1012 could implement some form of artificial intelligence such as a neural network, an expert system, etc. In any case, the processor 1012 of the current embodiment can process various images as disclosed herein.

With regard to the transmitter 1014, this device can provide communications between the camera mount 1002 and the remote station 1004 among other devices. It is envisioned that the transmitter 1014 could include a receiver and or other components to allow two-way communication between the camera mount 1002 and other devices. In the current embodiment, the transmitter 1014 provides for transmitting images from the camera mount 1002 to the remote station (and can allow for control signals to be received from the remote station 1004).

With continuing reference to FIG. 10, and in some situations, it is anticipated that users might want to capture images of some scenes with controlled lighting. For instance, a flash, continuous light or strobe might be used to improve the capture of some images. Accordingly, the lighting subsystem 1016 includes flashes, strobes, and other types of lighting as desired. The lighting subsystem 1016, more specifically, can be configured to provide light for underwater scenes which tend to be darker than the corresponding over water scenes. The lighting subsystem 1016 can, if desired, include light-level sensors thereby allowing for automatic operation of the lighting subsystem 1016.

Moreover, various embodiments include the propulsion subsystem 1018 and/or the buoyancy control subsystem 1020. The propulsion subsystem can be provided so that users need not provide the motive force to move the camera mount 1002 about its environment. Thus, the propulsion subsystem 1018 can include various motors, engines, etc. and/or or propellers, jets, etc. In the meantime, it might be desired for the camera mount 1002 to maintain its position and/or orientation while floating in one of the various media in which it might be partially or entirely immersed. Accordingly, the buoyancy control subsystem 1020 can include the weights 508 and/or flotation aids 510 illustrated by FIG. 5. The floatation aids could be air filled containers, expanded (not extruded) polystyrene foam, and/or Styrofoam® objects, etc. In the alternative, or in addition, the buoyancy control subsystem 1020 could be an active system in that it might include various tanks, pipes, pumps, fans, etc. to (re)position water, air, ballast, etc. in various locations on the mount 500 to control the position and/or orientation of the camera mount 1002 in a particular media.

With ongoing reference to FIG. 10, the remote station 1004 can be used to process the various images 122 and 124 captured by the camera mount 1002 and control the camera mount 1002 (among other functions). As such, it includes the receiver 1022, the operator interface 1024, the processor 1026, the network interface 1028, and perhaps other components (such as a memory).

The operator interface 1024 can include various pieces of hardware and/or software and can include a graphical user interface or even a hardwired console if desired. It provides the functionality, in the current embodiment, for a user to control the camera mount 1002 and to process images in accordance with the current disclosure. The processor 1026 can be any type of processor and can provide functionality associated with processing various images, controlling the camera mount 1002, executing user commands, providing information to users, etc. As illustrated by FIG. 10, the remote station 1004 can also include the network interface 1028. The system 1000 can, therefore, communicate with devices, users, applications, etc. residing on a network or devices associated therewith. For instance, the network interface can connect the system 1000 to the Internet.

The system 1000 therefore allows the cameras 1006 and 1008 to capture images 122 and/or 124 and store them in the memory 1010 of the camera mount or of other devices. These images 122 and 124 can be transmitted via the transmitter 1014 to storage devices of the remote station 1004. Embodiments also allow these captured images 122 and 124 to be processed by the processor 1012 to create dual-media images 102. The dual-media images 102 can be stored in the memory 1010 of the camera mount 1002 and/or can be transmitted to the remote station 1004 for storage, viewing, printing, distribution, etc.

Moreover, the processor 1012 can control the camera mount 1002 including the cameras 1006 and 1008. More particularly, the processor 1012 can be programmed to send pan, tilt, and zoom (PTZ1 and PTZ 2) controls signals to the cameras 1006 and 1008. These PTZ1 and 2 signals can point the cameras 1006 and 1008 at the subject 104 and (if the processor is programmed to perform object tracking) can maintain the aim of the cameras 1006 and 1008 on the subject 104. In addition, the processor 1012 can perform auto-focus functions for the cameras 1006 and 1008. In some embodiments, the processor 1012 can also send timing or synchronization signals SYNCH to the cameras 1006 and 1008. If desired, various feedback signals can originate at the cameras 1006 and 1008 and be sent to the processor 1012 to provide the processor 1012 feedback regarding the status of the cameras 1006 and 1008.

The processor 1012 can also be programmed to control the other subsystems 1016, 1018, and 1020. For instance, the processor 1012 can be programmed to determine whether or not (and/or the degree to which) the lighting subsystem 1016 lights various over water and underwater scenes. As such it can sense (via appropriate sensors) ambient light levels and respond accordingly. Moreover, the processor 1012 can control the propulsion subsystem 1018 to, for instance, maintain the cameras 1006 and 1008 at a given distance from the subject 104 and to keep the cameras 1006 and 1008 in a perpendicular relationship with respect to the subject 104. If the processor 1012 includes object (subject 104) tracking functionality, it can use the information derived there from to control the propulsion subsystem 1018.

In some embodiments, the processor 1012 can control the buoyancy control subsystem 1020. For instance, if the buoyancy control subsystem 1020 is active, the processor can turn on/off the pumps, fans, etc. therein and can open/close valves, damper, etc. as might be desirable to control the orientation of the camera mount 1002. It can therefore shift ballast about the camera mount 1002 as might be desired. Thus, should a wave or disturbance upset the camera mount 1002 (or even flip it over) the buoyancy control subsystem 1020 can right (and/or maintain the orientation of) the camera mount 1002.

Furthermore, a user (or the processor 1026) of the remote station 1004 can control the camera mount 1002. To do so, the user can receive information from the camera mount 1002 at the operator interface 1024 and send commands to the camera mount 1002 via the combination of the receiver 1022 and transmitter 1014. Users (or the processor 1026) of some embodiments can also process over water images 122 and underwater images 124 to create dual-media images 102. More specifically, the system 1000 can capture sequential pairs of synchronized images 122 and 124, process them to form a sequence of dual-media images 102, and output them as flip books 134, moving images (for instance, video) 146, etc. as desired.

This document discloses systems, apparatus, processes, etc. for capturing dual-media images and more particularly for capturing over-underwater images of swimmers and other subjects near the surface of the water.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A process comprising:
accepting an above-water image of a subject as taken by a first camera at an over water viewpoint;
accepting an underwater image of the subject which is synchronized with the over water image and taken by a second camera at an underwater viewpoint which was in alignment with and near the over water viewpoint at the time that the images were captured;
scaling at least one of the images to a scale associated with the other image;
removing a boundary artifact from the underwater image;
combining the images with the boundary artifact removed from the underwater image to form an dual-media image of the subject; and
outputting the dual-media image.

2. A process comprising:
accepting a first image of a subject at least partially situated in a first media, the first media and a second media defining a boundary there between, the first image being as captured from a viewpoint in the first media;
accepting a second image as captured from a viewpoint in the second media which is aligned with and near the first viewpoint, the first and second images being synchronized;
removing an artifact associated with the boundary from at least one of the images;
scaling at least one of the images to a scale;
combining the images to form a dual-media image of the subject; and
outputting the dual-media image.

3. The process of claim 2 further comprising synchronizing the capture of the first image and the second image.

4. The process of claim 2 further comprising aiming a first camera at the first viewpoint at the subject and aiming a second camera at the second viewpoint at the subject.

5. The process of claim 2 wherein the combining of the first and second images further comprises adjusting a relative position of the first image with respect to the second image to cause a portion of the subject in the dual-media image to have an aspect ratio that is approximately the same as an aspect ratio of a corresponding portion of the subject.

6. The process of claim 2 further comprising following the subject while obtaining the first and second images.

7. The process of claim 2 wherein the first media is water and the second media is air.

8. The process of claim 2 wherein removing the boundary artifact further comprises detecting a contrast between a portion of the boundary and a portion of one of the media which is adjacent to the portion of the boundary.

9. The process of claim 8 wherein the removing of the boundary artifact further comprises detecting a contrast between the portion of the boundary and a portion of the other media which is adjacent to the portion of the boundary.

10. A system comprising:
a camera mount defining a first mount point and a second mount defining a distance between the attachment points;
a first camera mounted to the camera mount at the first mount point;
a second camera mounted to the camera mount at the second mount point, the cameras to be aimed at a subject a distance away from the camera mount and to be set to two focal lengths whereby the subject to be partially situated in a first media and in a second media, the first camera to be located in the first media and the second camera to be located in the second media whereby the system to capture over and underwater images of the subject.

11. The system of claim 10 wherein the first and the second media to have different indices of refraction.

12. The system of claim 10 further comprising an adjustment mechanism to adjust the distance between the attachment points.

13. The system of claim 10 further comprising a first pivot operatively connected to the first mount point.

14. The system of claim 10 wherein one of the cameras is water resistant.

15. The system of claim 10 further comprising a buoyancy control subsystem.

16. The system of claim 10 further comprising a motor coupled to the camera mount and being adapted to propel the system through one of the media.

17. The system of claim 10 further comprising a timer in communication with the first and the second camera to synchronize the first and the second cameras.

18. The system of claim 10 further comprising a memory in communication with the cameras to store images taken by the cameras.

19. The system of claim 10 further comprising a processor in communication with the cameras to process the images taken by the cameras.

20. The system of claim 10 wherein the first media is water and wherein the second media is air.
